(19) United States
(12) Patent Application Publication
(10) Pub. No.: US 2011/0238511 A1
(43) Pub. Date: Sep. 29, 2011

(54) FUEL DISPENSER PAYMENT SYSTEM AND METHOD

(76) Inventors: Steve H. Park, Kernersville, NC (US); Andrew Robinson, Hillsborough, NC (US)

(21) Appl. No.: 13/041,753

(22) Filed: Mar. 7, 2011

Related U.S. Application Data
(60) Provisional application No. 61/311,376, filed on Mar. 7, 2010.

(51) Int. Cl. G06Q 20/00

(52) U.S. Cl. 705/17; 705/39

(57) ABSTRACT

A system and method for effecting payment transactions comprising a card reader configured to encrypt a first portion of payment card data received by the card reader from a payment card according to a first encryption scheme associated with the financial institution responsible for an account associated with the payment card and to encrypt a second portion of the payment card data according to a second encryption scheme, where the first portion is sufficient to identify the payment card or account number and to effect a payment transaction involving the payment card or account and where the second portion is sufficient to identify the financial institution but insufficient to identify the payment card or account number.

### CROSS REFERENCE TO RELATED APPLICATIONS

This application claims the benefit of U.S. provisional patent application No. 61/311,376, filed on Mar. 7, 2010, the entire disclosure of which is hereby incorporated by reference in its entirety as if set forth verbatim herein and relied upon for all purposes.

### FIELD OF THE INVENTION

The present invention relates to a payment system for a fuel dispenser and a method for effecting financial transactions using the same.

### BACKGROUND OF THE INVENTION

Systems configured to effect transactions involving payment cards, including credit and debit cards, must comply with certain security requirements, such as the Payment Card Industry Data Security Standards, or “PCI-DSS.” One manner by which this is accomplished is to encrypt data received from the payment card according to an internal encryption scheme used by the system. Prior to transmitting the relevant portion of the payment card data to the financial institution responsible for the payment card, the payment card data is decrypted according to the internal encryption scheme and then re-encrypted according to an encryption scheme required by the financial institution. As a result, at least one device within the system is configured to handle the payment card data in an unencrypted format following the initial receipt of the payment card data. This device must adhere to heightened security requirements imposed on such devices, which, consequently, can substantially increase the manufacture and maintenance costs of the system.

### SUMMARY OF THE INVENTION

The present invention recognizes and addresses the foregoing considerations, and others, of prior art construction and methods.

In this regard, one aspect of the present invention provides a system for encrypting payment card data associated with an account maintained by a financial institution. The system comprising a payment card reader configured to receive data from a payment card and encrypt the payment card data according to a first encryption scheme associated with the financial institution. The payment card reader is also configured to encrypt a selected portion of the payment card data according to a second encryption scheme, where the selected portion of the payment card data comprises data sufficient to identify the financial institution associated with the account.

Another aspect of the present invention provides a method for effecting a payment transaction involving a payment card associated with an account maintained by a financial institution. The method comprises receiving payment card data from a payment card at a payment card reader and encrypting the payment card data at the payment card reader according to a first encryption scheme. The payment card data is sufficient to identify the account and the first encryption scheme is associated with the financial institution. The method also comprises encrypting a selected portion of the payment card data at the payment card reader according to a second encryption scheme. The selected portion is sufficient to identify the financial institution but insufficient to identify the account.

The accompanying drawings, which are incorporated in and constitute a part of this specification, illustrate one or more embodiments of the present invention.

### BRIEF DESCRIPTION OF THE DRAWINGS

A full and enabling disclosure of the present invention, including the best mode thereof directed to those skilled in the art, is set forth in the specification, which makes reference to the appended drawings, in which:

FIG. 1 is a partially schematic, perspective view of a fueling environment in accordance with an embodiment of the present invention;

FIG. 2 is a partially schematic, perspective view of a fuel dispenser that may be used in the fueling environment of FIG. 1 in accordance with an embodiment of the present invention;

FIG. 3 is a schematic representation of exemplary communication paths utilized by the fueling environment of FIG. 1 in accordance with an embodiment of the present invention; and

FIG. 4 is a flowchart illustrating an exemplary method for effecting a payment transaction in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

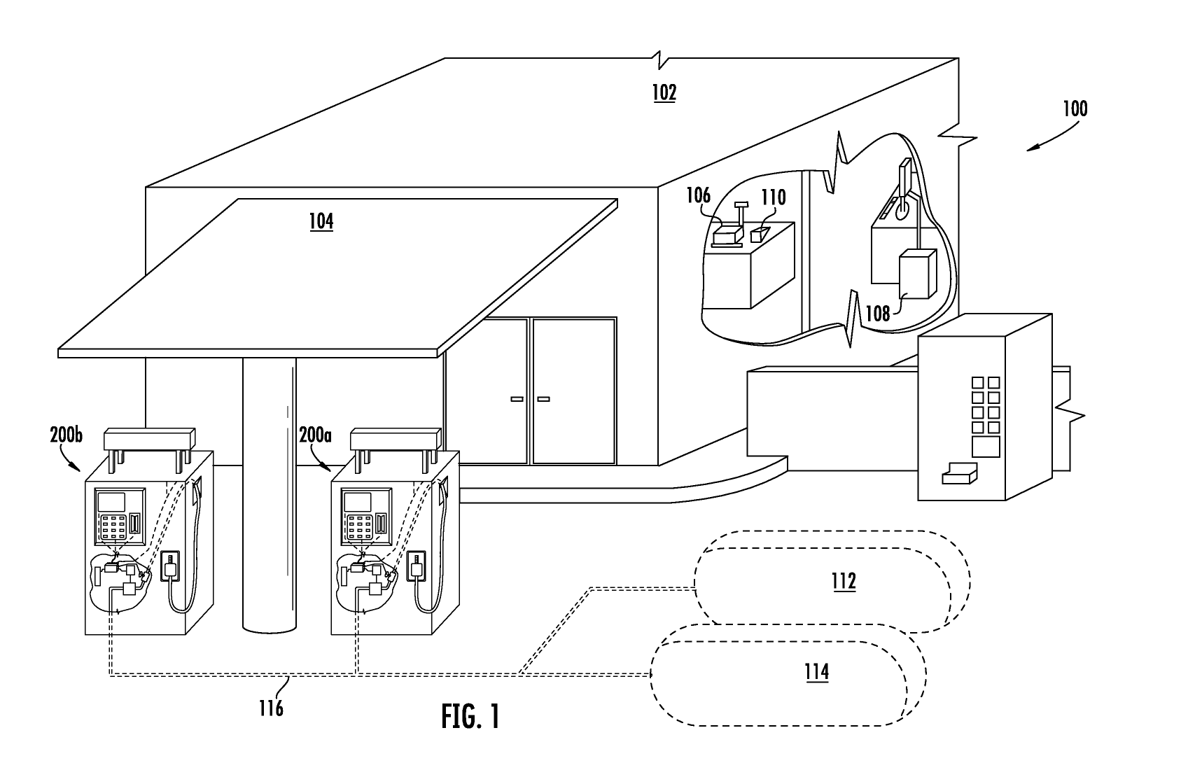

FIG. 1 is a diagrammatic perspective view of a fueling environment 100 adapted to provide fuel to a customer and to accept payment for the dispensed fuel. Fueling environment 100 comprises at least one fuel dispenser 200a and a central facility 102. Typically, one or more additional fuel dispensers, such as fuel dispenser 200b, may also be included within fueling environment 100. In the presently-described embodiment, fueling environment 100 also includes a canopy system 104 connected to central facility 102 that provides shelter to fuel dispensers 200a and 200b.

Central facility 102 comprises a point-of-sale device (“POS”) 106 and a site controller 108 and may include additional computers, such as cashier and/or manager workstations. In the embodiment illustrated, POS 106 comprises an associated card reader and payment terminal 110. Each of POS 106 and site controller 108 may also include a display, a touchscreen, and/or other devices, such as a printer. It should be understood that the functionality of POS 106, site controller 108, and any additional computers within central facility 102 may be incorporated into a single computer or server. Alternatively, these computing devices may be operatively interconnected via a local area network (“LAN”). An example of a suitable system that may be used in the present invention that combines the functions of POS 106 and site controller 108, to which multiple payment terminals 110 may be operatively connected, is the APPLAUSE system offered by GILBARCO INCORPORATED of Greensboro, N.C.

Fueling environment 100 may include a number of other components to facilitate the dispensing of fuel as should be understood by those skilled in the art. In the example provided by FIG. 1, for instance, fueling environment 100 includes two underground storage tanks (“USTs”) 112 and 114 configured to store fuel that is available for purchase. For example, USTs 112 and 114 may be stocked with respective grades of fuel. USTs 112 and 114 are in fluid communication with an underground piping network 116 to which dispensers 200a and 200b are connected. As a result, fuel stored within USTs 112 and 114 may be delivered to the dispensers for purchase.

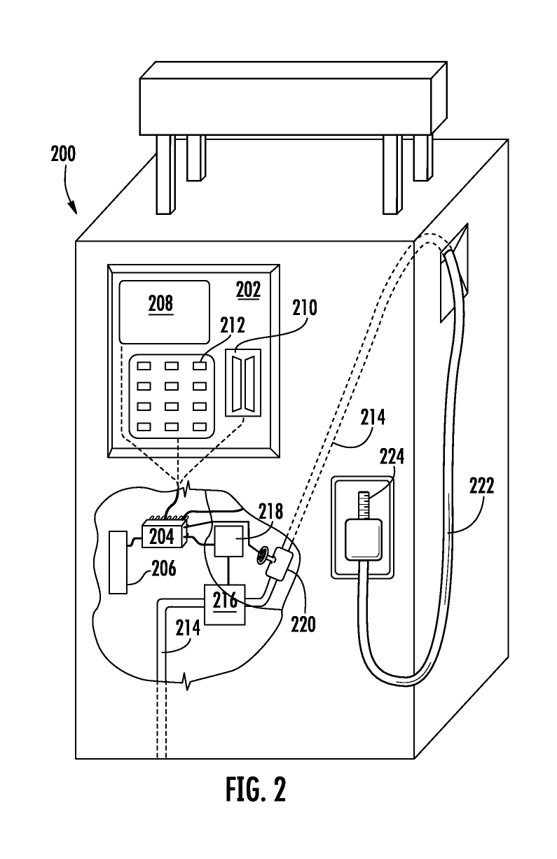

FIG. 2 is a partially schematic, perspective view of a fuel dispenser 200 that may be used as fuel dispensers 200a and 200b of FIG. 1. Fuel dispenser 200 comprises a user interface 202, a processing device 204, and memory 206. User interface 202 includes a display 208, a card reader 210, and a numeric pad 212. Processing device 204 is operatively connected to memory 206, as well as the components of user interface 202, including display 208, card reader 210, and numeric pad 212. User interface 202 may comprise other components operatively connected to processing device 204, such as a cash acceptor and/or a receipt printer, as should be understood in the art.

For purposes of the ensuing explanation, it should be understood that card reader 210 may be any device or combination of devices configured to receive data from cards or other instruments supplied by customers that contain account information. For instance, card reader 210 may be a magnetic stripe card reader, a smart card reader, a contactless card reader, a radio frequency (“RF”) reader, or any combination thereof. It should therefore be understood that the term “payment card” as used herein is intended to encompass magnetic stripe cards, smart cards, contactless cards, and RF devices, as well as other forms of cards and devices that are configured to store and provide account information. In the presently-described embodiment, card reader 210 is configured to accept account information from various types of payment cards, including credit and debit cards, prepaid and gift cards, fleet cards, and any local/private cards accepted by fueling environment 100. It should be appreciated that card reader 210 may also be configured to receive and process account information from non-payment and other cards, such as loyalty, frequent shopper, rewards, points, advantage, and club cards, as explained in more detail below.

As should be understood by those skilled in the art, fuel dispenser 200 also includes various fuel handling components configured to facilitate the delivery of fuel to a vehicle. For instance, fuel dispenser 200 additionally comprises a piping network 214, a meter 216, a pulser 218, a valve 220, a hose 222, and a nozzle 224. (One skilled in the art will appreciate that some of these will be duplicated in dispensers intended to deliver multiple fuel grades.) Processing device 204 is operatively connected to one or more of these components, such as pulser 218 and valve 220, in order to control their operation and to manage the delivery of fuel by fuel dispenser 200. Piping network 214 is in fluid communication with underground piping network 116 (FIG. 1) in order to receive fuel from the USTs. Piping network 214, hose 222, and nozzle 224 are also in fluid communication in order to supply the fuel to a vehicle, as should be understood in the art.

User interface 202 is configured to facilitate the dispensing of fuel and the acceptance of payment for the dispensed fuel. For instance, display 208 is configured to provide instructions to a customer regarding the fueling process, while card reader 210 and numeric pad 212 are configured to accept payment information provided by the customer. That is, card reader 210 is configured to receive account information from a payment card, such as a credit or debit card, that is presented to the card reader. Numeric pad 212 is configured to receive information from a customer associated with the payment card, such as a personal identification number (“PIN”) of a debit card or the billing zip code of a credit card. As noted above, other devices may also be included within user interface 202, which are configured to facilitate financial transactions for the dispensed fuel. For example, the cash acceptor may be configured to handle transactions involving cash payments, while the receipt printer is configured to print a receipt upon completion of the fueling process if desired, as described below. Processing device 204 is preferably configured to handle the communication of all data transmitted to and received from the components of user interface 202.

It should be understood that user interface 202 may also be configured to exchange information with a customer unrelated to the fueling transaction. For instance, display 208 may be configured to provide advertisements or other information to the customer, such as that regarding nearby hotels and restaurants. Numeric pad 212 may be configured to receive a selection from the customer regarding the displayed information, such as whether the customer is interested in nearby amenities.

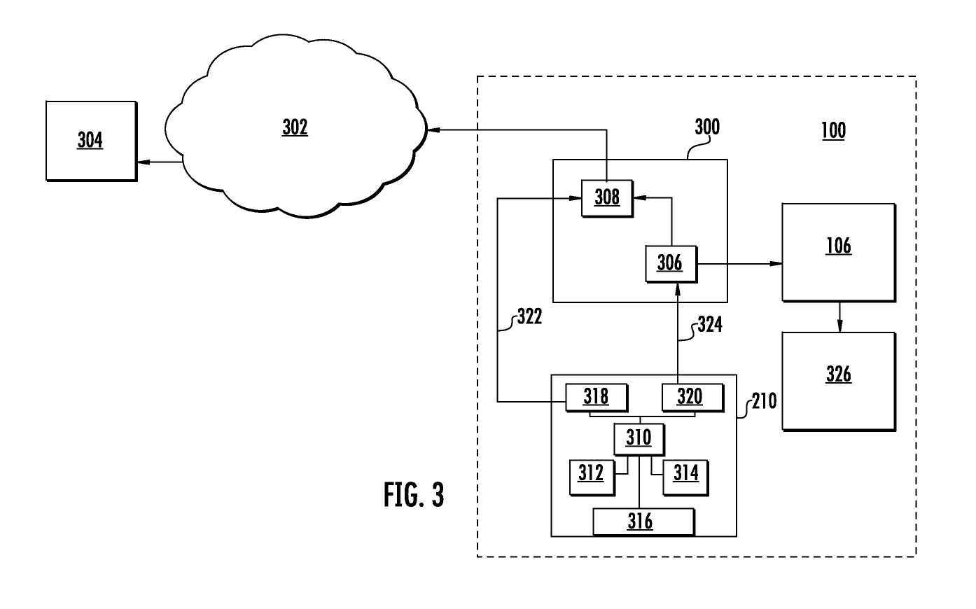

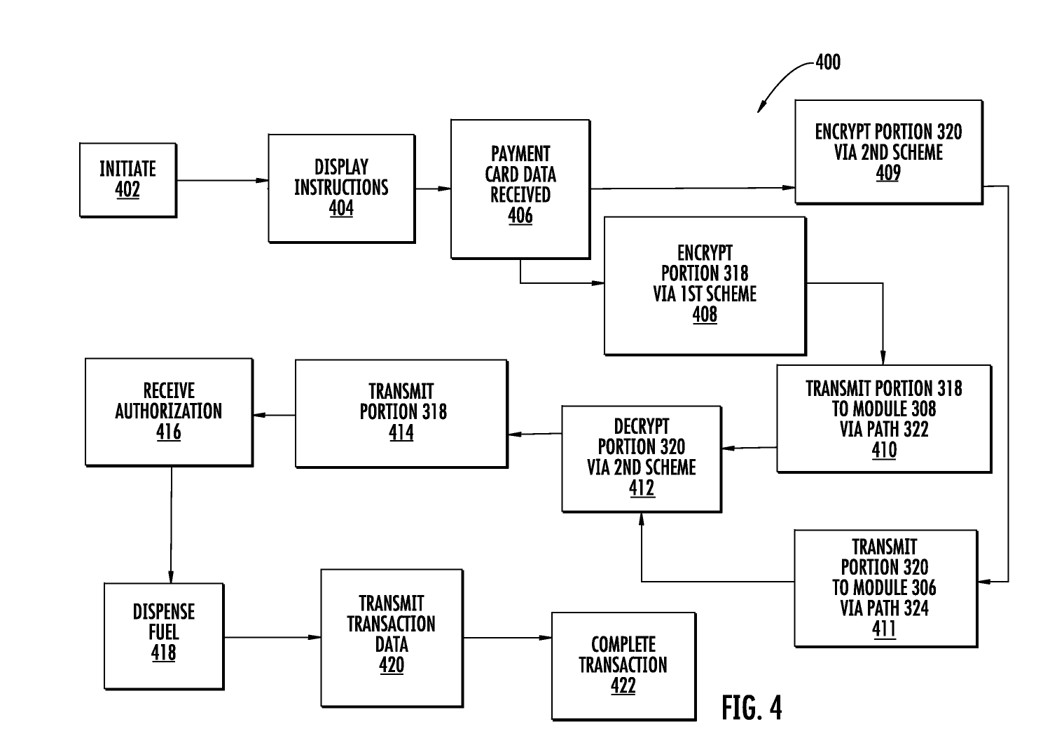

FIG. 3 is a schematic representation of exemplary communication paths employed by certain components of fueling environment 100 in one embodiment. A device 300 operatively connects POS 106 to card reader 210 in this embodiment. While FIG. 3 illustrates the connections between device 300 and both card reader 210 and POS 106 to be direct communication paths, it should be understood that each connection may be an indirect path via the LAN and/or one or more other devices, such as routers, switches, and dispenser hubs. For example, card reader 210 is configured to transmit data to device 300 via processing device 204 (FIG. 2). Device 300 also facilitates communication of the devices within fueling environment 100, such as card reader 210, with devices external to the fueling environment. Communication with external devices may be accomplished via a wide area network (“WAN”) 302, such as the Internet. In the presently-described embodiment, device 300 is configured to handle the sensitive or confidential payment card data received by card reader 210 in order to effect payment transactions. An example of such a device is the enhanced dispenser hub described in U.S. Published Patent Application Number 2010/0268612, entitled “Payment Processing System for Use in a Retail Environment Having Segmented Architecture,” which is hereby incorporated by reference in its entirety for all purposes as if set forth verbatim herein. It should be appreciated that POS 106, site controller 108 (FIG. 1), and/or other devices may comprise device 300 without departing from the scope of the present invention. In the presently-described embodiment, device 300 includes two modules 306 and 308 configured to handle data received from card reader 210. Modules 306 and 308 may be separate, physical modules in one embodiment but are preferably two separate software modules in another embodiment. Operation of modules 306 and 308 is described in more detail below with respect to FIG. 4.

As is well-known, at least one server 304 external to fueling environment 100 and maintained by a third-party, such as a financial institution, is connected to WAN 302. It should be understood that fueling environment 100 may be operatively connected to multiple such servers maintained by various financial institutions via WAN 302 in order to carry out financial transactions involving customer accounts maintained by the different financial institutions as explained in more detail below. For purposes of the ensuing explanation, server 304 is associated with a financial institution referred to herein as “Bank A” and is tasked with carrying out transactions on Bank A's behalf for accounts maintained by the bank.

In the presently-described embodiment, card reader 210 comprises a secure encryption processor 310 operatively connected to a secure memory or storage unit 312. Card reader 210 is configured to be tamperproof so that, in the case of unauthorized access, the card reader's contents, including data contained in secure memory 312 or handled by secure processor 310, are erased, deleted, or destroyed. An example of a suitable secure encryption processor and memory unit is set forth in U.S. Pat. No. 7,379,325. Card reader 210 may utilize other or additional tamperproof mechanisms and methods understood by those skilled in the art, such as those described in U.S. Pat. No. 4,811,288. The entire disclosures of U.S. Pat. Nos. 4,811,288 and 7,379,325 are incorporated by reference in their entirety as if set forth verbatim herein.

Card reader 210 preferably comprises a lookup table 314 operatively connected to secure processor 310. Lookup table 314 may be stored in a memory device separate from secure memory 312 as illustrated or may be stored in the secure memory. As should be understood by one skilled in the art, card reader 210 comprises a read mechanism 316 for receiving payment card data, such as a read head in the case of a magnetic stripe card reader, as well as at least one input-output (“I/O”) port for receiving and loading encryption information as explained below. For purposes of the ensuing explanation, “encryption information” is intended to encompass encryption schemes, algorithms, and/or keys.

FIG. 4 illustrates an exemplary process 400 used by the fueling environment for effecting a financial transaction. The following explanation of process 400 is made with reference to the components illustrated in FIGS. 1, 2, and 3. Process 400 begins at step 402, where secure processor 310 receives and stores encryption information associated with a financial institution in secure memory 312. Secure processor 310 also receives encryption information used to encrypt communications between devices within fueling environment 100, referred to herein as “local encryption information” for purposes of explanation, and stores the information in secure memory 312 at step 402.

In one embodiment, financial institutions transmit the encryption information to device 300 to be used to communicate securely with the respective institution. For example, server 304 transmits encryption information for Bank A to device 300 to be used to encrypt communications between fueling environment 100 and server 304. In this embodiment, device 300 transmits the encryption information received from the financial institutions, as well as the local encryption information, to card reader 210 for installation and storage. In another embodiment, encryption information is installed directly to card reader 210 using its I/O port. That is, the encryption information may be provided to card reader 210 via its I/O ports by connecting a device containing the encryption information directly to the card reader. It should be appreciated that step 402 may be performed at the time when card reader 210 is installed in dispenser 200.

Card reader 210 stores an association in lookup table 314 between a type of card and the encryption information for that type of card installed to the card reader. That is, lookup table 314 includes an indication of the encryption information to be used by secure processor 310 for each type of card from which card reader 210 is configured to receive data. For instance, secure processor 310 stores an identification of the encryption information to be used when a loyalty card is presented to card reader 210 in lookup table 314 and stores the encryption information in secure memory 312. When a customer presents a loyalty card to card reader 210, secure processor 310 identifies the card as a loyalty card, retrieves the identification of the encryption information associated with loyalty cards from lookup table 314, and retrieves the encryption information from secure memory 312. Secure processor 310 encrypts the data received from the card using the encryption information as described in more detail below. Similarly, secure processor 310 stores an identification of the encryption information to use upon receipt of data from a payment card, such as a credit or debit card.

The presently-described embodiment accommodates for scenarios where different financial institutions utilize differing encryption information for payment cards maintained by the respective institution. In this embodiment, lookup table 314 associates encryption information with each financial institution. For example, the encryption information for Bank A may be different than the encryption information for another financial institution even though they handle the same type of payment cards. When secure processor 310 receives account information from a payment card, it is able to retrieve the identification of the encryption information from lookup table 314 for the financial institution responsible for the account. As a result, secure processor 310 is then able to retrieve the encryption information associated with that financial institution from secure memory 312. Secure processor 310 then encrypts the data received from the payment card using the encryption information required by the particular financial institution, as explained in more detail below.

It should be appreciated that encryption information for a financial institution may be associated with the institution in lookup table 314 through the use of a unique identifier that corresponds to the financial institution. It should also be appreciated that the unique identifier is included within any data received from a payment card so that the financial institution responsible for the payment card can be identified. For example, the bank identification number, or BIN, that is associated with a financial institution may serve as such a unique identifier. Since the unique identifier, such as the BIN, is used to route data to the correct financial institution to effect transactions for a payment card maintained by the financial institution, the unique identifier is included in the data provided by the payment card. For example, the first six digits of an account number received from a credit card equate to the BIN and are used to route data corresponding to the credit card to the correct financial institution. Secure processor 310 is able to extract the unique identifier from the payment card data, identify the financial institution, and retrieve the correct encryption information from lookup table 314 for the financial institution that corresponds to the unique identifier. For instance, secure processor 310 is configured to extract the BIN from an account number included within the payment card data and identify the encryption information associated with the BIN using lookup table 314. Thus, in such an embodiment, lookup table 314 associates encryption information with each BIN stored in the table specific to the financial institution identified by the BIN.

At step 404, display 208 presents instructions to a customer whose vehicle is positioned adjacent to fuel dispenser 200. The instructions may include the manner by which to begin the fueling process, such as instructing the customer to present a payment card to card reader 210. At step 406, read mechanism 316 receives data from any payment card presented to card reader 210 and transmits the data to secure processor 310. Upon receipt of the payment card data, secure processor 310 generates a transaction id and associates it to the received data. Those skilled in the art should appreciate that the transaction id may be associated with other information corresponding to the payment card data, such as the date and time it was received by card reader 210.

By comparing the data stored in lookup table 314 to that received from the payment card, secure processor 310 determines the type of payment card presented to card reader 210, such as, for example, whether the payment card is a credit card or fleet card. Secure processor 310 extracts information from the received data sufficient to identify the financial institution responsible for the payment card. For instance, secure processor 310 extracts the BIN from the account number included within the data received from the payment card. Secure processor 310 identifies the encryption information for the financial institution using the unique identifier and lookup table 314. Secure processor 310 retrieves the encryption information for that financial institution from secure memory 312. In this example, secure processor 310 retrieves the encryption information from secure memory 312 for Bank A based on the BIN extracted from the payment card data. Secure processor 310 also retrieves the local encryption information for fueling environment 100. For purposes of the ensuing explanation, the encryption information for Bank A is referred to herein as “the first encryption scheme,” while the local encryption information is referred to herein as “the second encryption scheme.”

At step 408, secure processor 310 encrypts a portion 318 of the payment card data sufficient to effect a transaction using the payment card. Portion 318 includes the account number and may include other information, such as the account holder's name, address, and/or telephone number. In one embodiment, portion 318 includes all the data received by card reader 210 from the payment card. At step 410, secure processor 310 transmits portion 318, encrypted pursuant to the first encryption scheme, to module 308 of device 300, along with the transaction id.

At step 409, secure processor 310 encrypts a portion 320 of the payment card data received by card reader 210 pursuant to the second encryption scheme. Portion 320 includes data received from the payment card sufficient to identify the financial institution responsible for the payment card. That is, portion 320 includes the unique identifier associated with Bank A in this example. In this example, portion 320 includes the BIN for Bank A from the account number, for instance, that was included in the data received from the payment card.

While portion 320 may be configured to only include the financial institution's unique identifier, such as the BIN, it should be understood that the portion may nonetheless include additional digits of the account number or other information depending on the requirements of fueling environment 100. For instance, portion 320 may include a predefined number of digits of the account number for recording or reporting purposes, such as the last four digits of the number. That is, portion 320 may comprise information necessary for POS 106 to carry out any required tasks, such as for recording or tracking purposes, as described in more detail below. Regardless, it should be understood that secure processor 310 is configured to only encrypt and transmit a portion of the payment card data that is insufficient to identify the account number of the payment card. That is, portion 320 includes the unique identifier of Bank A but does not include the account number of the payment card. As a result, portion 320 cannot be used to identify or discern the account number.

Thus, any device of fueling environment 100 that receives or has access to portion 320 is unable to access enough payment card data to identify the account number of the payment card. As a result, portion 320 is not sufficient to effect a transaction using the card. At step 411, secure processor 310 transmits portion 320 to module 306 via another secure channel 324, along with the transaction id.

In one embodiment, secure channels 332 and 324 are separate physical paths. It should be understood, however, that secure channels 322 and 324 may extend from card reader 210 to device 300 via the same physical path in at least one embodiment. Those skilled in the art should appreciate that in such an embodiment, though, data transmitted over the same physical path via secure channels 322 and 324 are separate and distinct.

It should be understood from the following description that the first encryption scheme may be identical to the second encryption scheme but may utilize different algorithms. For example, both schemes may adhere to the Data Encryption Standard (“DES”) created by International Business Machines (“IBM”) but makes use of differing encryption algorithms. It should be further understood that the two encryption schemes may utilize the same or similar encryption algorithms but may utilize different encryption keys. For instance, both schemes may employ the Triple Data Encryption Algorithm, or “Triple DES” (“3DES”), but may use different 3DES encryption keys. Regardless of the standards or the algorithms used, those skilled in the art should appreciate that the manner by which portion 318 is encrypted at step 408 is separate and distinct from the manner by which portion 320 is encrypted at step 409, although the two may use similar or identical encryption standards and/or algorithms. It should be understood that the first encryption scheme is tailored to the requirements of the financial institution, while the second encryption scheme is tailored to the requirements of fueling environment 100, in this embodiment.

At step 412, module 306 decrypts portion 320 of the payment card data according to the second encryption scheme. It should be understood that the key used to decrypt portion 320 according to the second encryption scheme may be different than the key used to encrypt portion 320 according to the second encryption scheme, such as in a scenario utilizing an asymmetric key algorithm. It should also be understood, however, that the second encryption scheme may instead utilize symmetric key algorithms. Regardless, module 306 extracts or identifies the unique identifier from portion 320 at step 412. In this example, module 306 identifies the BIN associated with Bank A from portion 320. Module 306 uses the BIN to identify Bank A and/or server 304 and provides the identification to module 308, along with the transaction id.

At step 414, module 308 identifies sever 304 as the system tasked with effecting transactions involving the payment card based on the data received from module 306. Module 308 prepares and transmits a data packet to server 304. The data packet includes portion 318, encrypted pursuant to the first encryption scheme, and may include a header appended to the beginning of portion 318 and other information, such as the transaction id, appended to the end. The header may include data required by the financial institution to which the data packet is directed. The arrangement and construction of the header should be understood by those skilled in the art and are therefore not described in more detail.

At step 414, module 306 also transmits portion 320 to POS 106 (and/or site controller 108), including the transaction id, for internal use by fueling environment 100. For instance, POS 106 may store the data for reporting and tracking purposes and/or to handle a credit, chargeback, replay, or dispute with the financial institution. POS 106 may also use the data to print a report or perform other ancillary tasks at a later juncture, as explained below. It should be understood that module 306 may re-encrypt the data using the second encryption scheme before transmitting it to POS 106.

At step 416, server 304 either authorizes or denies the transaction based on the payment information transmitted by device 300 and returns data representative of the decision to device 300. The data returned by server 304 may include the transaction id transmitted by module 308 to server 304 at step 414. As should be understood, the transaction id allows fueling environment 100 and server 304 to track the transaction and information associated with the transaction. Those skilled in the art, however, should appreciate that fueling environment 100 may utilize any method known in the art to track the transaction both within and outside of the fueling environment without departing from the scope of the present invention. Device 300 transmits data to fuel dispenser 200 indicating whether the financial institution authorized the fueling transaction.

If fuel dispenser 200 receives an authorization, processing device 204 instructs valve 220 to open in order to allow the flow of fuel at step 418. When the customer activates nozzle 224 and valve 220 is open, fuel flows from at least one of USTs 112 and 114 to piping network 214 of fuel dispenser 200 via underground piping network 116. Meter 216 measures the flow of fuel as it flows through the meter, while pulser 218 transmits a signal to processing device 204 representative of the measurement.

Upon completion of the fueling process, fuel dispenser 200 transmits data to device 300 at step 420 including the volumetric and/or monetary amount of fuel delivered to the customer's vehicle. Device 300 then transmits at least a portion of the data to server 304 via WAN 302 in order to complete the transaction at step 422. Bank A performs any necessary tasks which may include charging or debiting the customer's account, as is well-known in the art. Bank A may return an acknowledgement to fueling environment 100 indicating that the transaction has been finalized.

Additionally, device 300 may transmit data to another device within fueling environment 100 in order to complete any ancillary tasks associated with the fueling process at step 420. For example, device 300 transmits the acknowledgement from Bank A to fuel dispenser 200 to be included on a receipt printed at the dispenser for the customer if desired. Device 300 may transmit the transaction id to fuel dispenser 200 with the acknowledgement so the dispenser can identify the transaction. Other information included within portion 320, such as the last four digits of the account number, may be included on the receipt, as should be understood in the art. In one embodiment, device 300 transmits encrypted portion 320 to fuel dispenser 200, which decrypts the portion to retrieve the information to be included on the receipt. In another embodiment, fuel dispenser 200 identifies portion 320 retained by the dispenser based on the transaction id, decrypts the portion, and extracts the information therefrom to be included on the receipt.

In one embodiment, device 300 also transmits the data to POS 106 at step 420 for storage and for use at a later time. For example, POS 106 may store the acknowledgement with portion 320 and the transaction id it received from device 300 at step 414. When instructed, POS 106 may transmit this information to a printer 326 associated with the POS to be included in a report output by the printer. It should be understood that POS 106 has access to the second encryption scheme in order to decrypt portion 320 when received or when data included therein is needed. In another embodiment where POS 106 is tasked with printing a receipt for the transaction, as described below for example, the POS uses the data received from device 300 to print the receipt. In such an embodiment, POS 106 decrypts portion 320 pursuant to the second encryption scheme and extracts the information to be included on the receipt. For instance, POS 106 extracts the last four digits of the account number included within portion 320 to be included on the receipt. Those skilled in the art should appreciate that POS 106 or fuel dispenser 200 may include other information on the receipt associated with the transaction, such as the transaction id. POS 106 and fuel dispenser 200 may also include additional information contained in portion 320 on the receipt, including the account holder's name.

In one embodiment, device 300 deletes portion 320 at step 422 once an acknowledgement is received that the transaction has been finalized. In another embodiment, device 300 deletes portion 320 at step 414 after device 300 transmits portion 320 to POS 106 for internal use. It should be appreciated that, after step 414, any device involved in the fueling transaction may possess the transaction id in order to identify the transaction and communicate with the other devices involved in the transaction regarding the same.

In one embodiment, module 308 transmits the data packet to server 304 at step 414 in order to preauthorize the fueling process. In such an embodiment, the data packet includes an indication that the transmission is for preauthorization purposes. In this embodiment, module 308 prepares another data packet to server 304 at step 420. The data packet includes portion 318, along with the final transaction amount and an indication to finalize the transaction. In another embodiment, where server 304 and fueling environment 100 have established an identifier for the transaction at steps 414 and 416, the server does not require the account number to finalize the transaction. Thus, module 308 does not include portion 318 in the data packet it transmits to server 304 at step 420.

In an embodiment where fueling environment 100 and server 304 identify the transaction with an id commonly-understood by the two systems, it should be appreciated that module 308 may delete portion 318 once device 300 has received an acknowledgement of the id from server 304 at step 416. Thus, fueling environment 100 is not in possession of data that includes the account number following step 416 in such an embodiment.

In this embodiment, device 300 is only required to transmit the transaction data, such as the amount of the transaction, and the unique id to server 304 at step 422 in order to complete the transaction. It should be appreciated that in such an embodiment, it is unnecessary for fueling environment 100 to retain a copy of any payment card data sufficient to identify the payment card or account number corresponding to the payment card even for reporting or other purposes. One skilled in the art will appreciate that the id is configured to identify the transaction only and cannot be used to identify the payment card or account number. The unique id may also be used for other purposes such as reporting, tracking, or to rerun the transaction, as described above.

In another embodiment, fuel dispenser 200 is operatively connected directly to WAN 302 and is configured to effect the payment card transaction. In such an embodiment, portion 318 is encrypted according to the first encryption scheme, and portion 320 is encrypted according to the second encryption scheme in a manner similar to that described above with respect to steps 406, 408, and 409. In this embodiment, however, fuel dispenser 200 identifies Bank A using the BIN identified from the account number and lookup table 314 and transmits portion 318 directly to server 304 at step 410. Any data returned by the financial institution is transmitted to fuel dispenser 200 in this embodiment. It should be understood that, in such an embodiment, the encrypted information is only maintained within fuel dispenser 200 and, specifically, within card reader 210. In this embodiment, portion 320 that cannot be used to identify the payment card or account number may still be encrypted according to the second encryption scheme and transmitted to POS 106, such as for reporting purposes. Thus, at least in one embodiment, only card reader 210 need comply with the standards established for devices that handle payment card data. In another embodiment, card reader 210 transmits the transaction id to POS 106 and deletes portion 320 as it is no longer necessary in this scenario. The transaction id is used from this point forward to identify the transaction and the data associated therewith.

In another embodiment, card reader 210 may be configured not to encrypt portion 320 according to the second encryption scheme since the payment card or account number cannot be identified solely based on the identifier unique to the financial institution responsible for the payment card. In one such embodiment, the unique identifier is used to identify the financial institution responsible for the account corresponding to the payment card and is then deleted. The payment card data is encrypted according to the first encryption scheme when received and transmitted to the applicable financial institution. Card reader 210 transmits the transaction id to POS 106 in this embodiment.

As explained above, secure processor 310 identifies the type of card presented to card reader 210 at step 406. Secure processor 310 also identifies the encryption information for the type of card at step 406. In another embodiment, secure processor 310 additionally identifies the manner by which the data received from the card should be encrypted at step 406 using lookup table 314. Should secure processor 310 identify the card as a loyalty card, for instance, lookup table 314 may indicate the data received from such cards should only be encrypted pursuant to the local/second encryption scheme. This may be because the account information of the loyalty card is only used within fueling environment 100. Thus, the data received from the loyalty card is not encrypted pursuant to a first encryption scheme and is not transmitted to module 308 via secure channel 322. Alternatively, lookup table 314 may indicate data received from loyalty cards should remain unencrypted in a scenario where such cards do not include any financial or personal data. It should thus be appreciated that lookup table 314 may be configured to identify multiple encryption schemes, paths, channels, and manners by which data received by card reader 210 should be handled depending on the type of card.

It should be understood from the above description that, while dispenser 200 (and, specifically, card reader 210) requires the encryption key of the first encryption scheme to encrypt the payment card data, no device within fueling environment 100 requires the decryption key of the first encryption scheme in a scenario where the encryption and decryption keys are different. Accordingly, the financial institution responsible for the first encryption scheme may be the only entity in possession of the decryption key. This prevents the payment card data from being decrypted prior to receipt of the information by the financial institution. Accordingly, card reader 210 is configured to transmit data sufficient to identify the payment card or the account number corresponding to the payment card in an encrypted format according to the first encryption scheme only. Those skilled in the art will appreciate that this prevents any device within fueling environment 100 from decrypting or otherwise identifying the payment card or the account number to which the payment card corresponds. As a result, it may be unnecessary for the other devices within fueling environment 100 to comply with the heightened security requirements related to devices that handle payment card data in an unencrypted format.

For example, the financial institutions may employ asynchronous encryption key scenarios and do not provide the decryption key to entities that handle payment cards for which the financial institutions are responsible. It should be understood that, in such a scenario, no device within fueling environment 100 other than card reader 210 is able to access or discern the account number of a payment card presented to the card reader. That is, once secure processor 310 encrypts portion 318 at step 408, no device within fueling environment 100 possesses the ability to decrypt portion 318 in order to discern the account number. If portion 318 is acquired by unauthorized means, it remains encrypted pursuant to the first encryption scheme. Moreover, fueling environment 100 does not have access to any amount of data after step 408 that can be used to determine the account number.

The description of process 400 above describes the receipt of payment card data by card reader 210. It should be appreciated that process 400 remains applicable in the event card reader 110 associated with POS 106 receives the payment card data instead. In the scenario where a customer enters central facility 102, for example, the payment card may be presented to card reader 110. Process 400 nonetheless proceeds in a manner similar to that described above with respect to FIG. 4.

It should be understood that the above description provides an end-to-end encryption process. That is, payment card data sufficient to identify the payment card or the account number associated with the payment card, as well as to effect a transaction using the payment card, is encrypted according to an encryption scheme provided by the financial institution responsible for the payment card. This information remains encrypted the entire time it is handled by the system; that is, from the time it is received until transmitted to the financial institution and deleted. Any other information used by the system is encrypted according to a second encryption scheme in a preferred embodiment and is insufficient to identify the payment card or the account number corresponding to the payment card. It should also be understood that, while the present invention is described with reference to a fueling environment, it may be incorporated into any retail environment configured to receive payment card data and carry out payment transactions using the payment card data.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those skilled in this art that the present invention is not limited to these embodiments since modifications can be made. Therefore, it is contemplated that any and all such embodiments are included in the present invention as may fall within the scope and spirit thereof.

What is claimed is:

1. A system for encrypting payment card data associated with an account maintained by a financial institution, the system comprising:
a payment card reader configured to:
receive data from a payment card;
encrypt a first portion of the payment card data according to a first encryption scheme associated with the financial institution, wherein the first portion of the payment card data is sufficient to identify the account; and
encrypt a second portion of the payment card data according to a second encryption scheme, wherein the second portion of the payment card data comprises data sufficient to identify the financial institution but insufficient to identify the account.

2. The system of claim 1 wherein the payment card reader identifies the first encryption scheme associated with the financial institution based on the second portion of the payment card data.

3. The system of claim 1 further comprising a fuel dispenser, wherein the fuel dispenser comprises the payment card reader.

4. The system of claim 1 further comprising:
a transaction device configured to:
decrypt the second portion of the payment card data according to the second encryption scheme;
identify the financial institution based on the second portion of the payment card data; and
transmit the first portion of the payment card data encrypted according to the first encryption scheme to the identified financial institution.

5. The system of claim 6 wherein the transaction device comprises a point-of-sale device (POS).

6. The system of claim 6 wherein the transaction device comprises an enhanced dispenser hub.

7. The system of claim 6 wherein the transaction device is a fuel dispenser, the fuel dispenser comprising the payment card reader and a processing device.

8. The system of claim 1 wherein the first portion of payment card data comprises the second portion of the payment card data.

9. The system of claim 1 wherein the account can be identified from the first portion of the payment card data encrypted according to the first encryption scheme.

10. The system of claim 1 wherein the second portion of the payment card data is a subset of the payment card data.

11. The system of claim 1 wherein the first portion of the payment card data is a subset of the data received from the payment card.

12. The system of claim 1 wherein the payment card data comprises the data received from the payment card.

13. The system of claim 1 wherein the first encryption scheme is provided by the financial institution.

14. The system of claim 6 wherein the second encryption scheme is provided by the transaction device.

15. The system of claim 1 wherein the second encryption scheme is the same as the first encryption scheme.

16. The system of claim 1 wherein the payment card reader comprises a magnetic stripe card reader.

17. The system of claim 1 wherein the payment card reader comprises a smart card reader.

18. The system of claim 1 wherein the payment card reader comprises a contactless card reader.

19. A method for effecting a payment transaction involving a payment card associated with an account maintained by a financial institution, the method comprising:
receiving payment card data from a payment card at a payment card reader;
encrypting a first portion of the payment card data at the payment card reader according to a first encryption scheme, wherein the first portion of payment card data is sufficient to identify the account and the first encryption scheme is associated with the financial institution; and
encrypting a second portion of the payment card data at the payment card reader according to a second encryption scheme, wherein the second portion of payment cards data is sufficient to identify the financial institution but insufficient to identify the account.

20. The method of claim 19 further comprising:
decrypting the second portion of the payment card data according to the second encryption scheme;
identifying the financial institution based on the second portion of the payment card data; and
transmitting the first portion of the payment card data to the financial institution.

21. The method of claim 19 further comprising:
decrypting the second portion of the payment card data according to the second encryption scheme; and
printing a part of the second portion of the payment card data on a document.

22. The method of claim 21 wherein the document is a receipt associated with the payment transaction.
